(19) United States
(12) Patent Application Publication
(10) Pub. No.: US 2022/0075555 A1
(43) Pub. Date: Mar. 10, 2022

(54) MULTI-SCALE CONVOLUTIONAL KERNELS FOR ADAPTIVE GRIDS

(71) Applicant: Intel Corporation, Santa Clara, CA (US)

(72) Inventors: Benjamin Ummenhofer, Unterhaching (DE); Vladlen Koltun, Santa Clara, CA (US)

(73) Assignee: Intel Corporation, Santa Clara, CA (US)

(21) Appl. No.: 17/528,829

(22) Filed: Nov. 17, 2021

Related U.S. Application Data
(60) Provisional application No. 63/233,042, filed on Aug. 13, 2021.

(51) Int. Cl. G06F 3/06

(52) U.S. Cl. CPC G06F 3/0655; G06F 3/0679; G06F 3/0604

(57) ABSTRACT

Systems, apparatuses and methods may provide for technology that selects elements of a multi-scale kernel according to resolutions in an adaptive grid, conducts convolutions on the adaptive grid with the selected elements of the multi-scale kernel, and generates a signed distance field based on the convolutions.

### CROSS-REFERENCE TO RELATED APPLICATIONS

The present application claims the benefit of priority to U.S. Provisional Patent Application No. 62/233,042 filed Aug. 13, 2021.

### TECHNICAL FIELD

Embodiments generally relate to the use of convolutional kernels in artificial intelligence (AI) technology. More particularly, embodiments relate to multi-scale convolutional kernels for adaptive grids.

### BACKGROUND OF THE DISCLOSURE

Three-dimensional (3D) reconstruction tasks may involve fusing data of multiple scales and/or resolutions (e.g., data organized as octrees or quadtrees). The octrees and/or quadtrees may be used to generate adaptive grids, which contain data at multiple resolutions. The adaptive grids typically cannot be processed with standard convolutional neural networks. As a result, sub-optimal performance may be experienced.

### BRIEF DESCRIPTION OF THE DRAWINGS

So that the manner in which the features of the present embodiments can be understood in detail, a more particular description of the embodiments may be had by reference to embodiments in the following detailed description, some of which are illustrated in the appended drawings. It is to be noted, however, that the appended drawings illustrate only typical embodiments and are therefore not to be considered limiting of its scope.

FIG. 1 is a comparative illustration of an example of a regular grid and an adaptive grid according to an embodiment;

FIG. 2 is a comparative illustration of an example of conventional convolution results and convolution results according to an embodiment;

FIG. 3 is a block diagram of an example of a 3D data processing pipeline according to an embodiment;

FIG. 4A is an illustration of an example of an application of multi-scale kernels to an adaptive grid according to an embodiment;

FIG. 4B is an illustration of an example of multi-scale kernel elements corresponding to the adaptive grid of FIG. 4A;

FIGS. 5A and 5B are illustrations of examples of adaptive grid cell mappings to multi-scale kernel elements according to embodiments;

FIG. 6A is an illustration of an example of spatial configuration keys according to an embodiment;

FIG. 6B is an illustration of an example of possible relative positions between center cells and face-adjacent neighbor cells according to an embodiment;

FIGS. 7A-7C are illustrations of examples of mesh results according to embodiments;

FIG. 8 is a flowchart of an example of a method of processing point cloud data according to an embodiment;

FIG. 9 is a flowchart of an example of a method of selecting elements of a multi-scale kernel according to an embodiment;

FIG. 10 is a block diagram of an example of a performance-enhanced computing system according to an embodiment;

FIG. 11 is an illustration of an example of a semiconductor package apparatus according to an embodiment;

FIG. 12 is a block diagram of an example of a processor according to an embodiment; and

FIG. 13 is a block diagram of an example of a multi-processor based computing system according to an embodiment.

### DETAILED DESCRIPTION

Technology described herein provides for specialized convolutional kernels that efficiently process multi-scale volumetric data stored in adaptive grids with (convolutional neural networks) CNNs. The technology described herein also provides for multi-scale convolutional kernels that span multiple resolution levels, which enables convolutions to be adapted to the discretization used in adaptive grids.

Adaptive data representations may be used to increase computational efficiency. Implementation of embodiments in software (and hardware) enables direct processing of these data representations with convolutional neural networks. This approach adds value by expanding the feature set of artificial intelligence (AI) accelerators and can also be used to postprocess data in 3D sensing devices (e.g., reconstruct surfaces from point cloud scans).

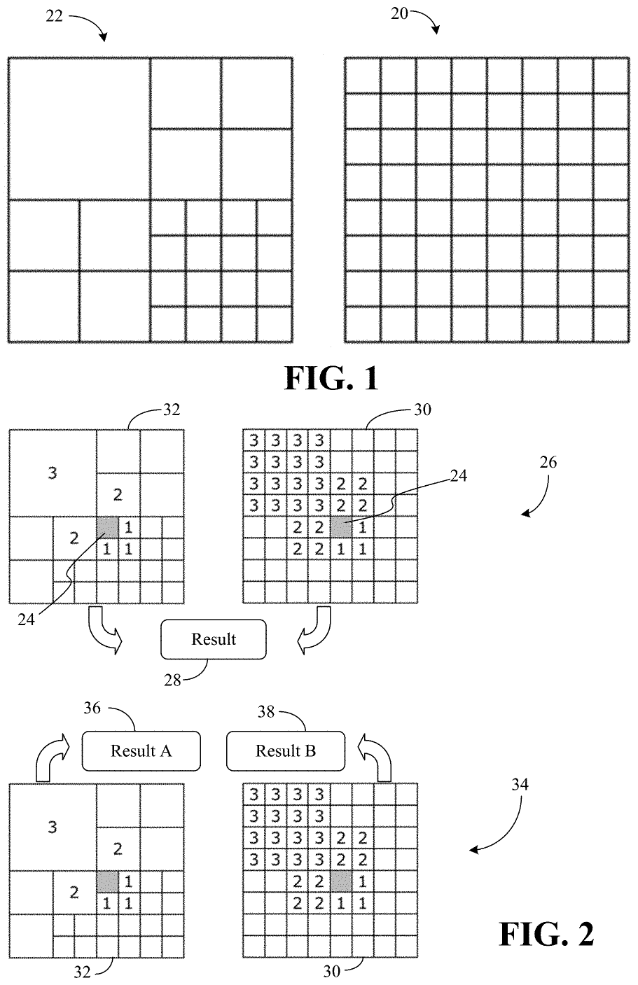

FIG. 1 shows a regular grid 20 that contains data at a single resolution. By contrast, an adaptive grid 22 contains data at multiple resolutions. In one example, the adaptive grid 22 is generated from a 3D reconstruction task that involves fusing data of multiple scales and/or resolutions (e.g., data organized as octrees or quadtrees). In such a case, the octrees and/or quadtrees are used to generate the adaptive grid 22.

Adaptive Grid Solvers: Simulation software packages such as, for example, ANSYS or COMSOL may be used to solve partial differential equations (PDEs) on the adaptive grid 22. Adaptive grid solvers may use discretization techniques such as a Finite Element Method to discretize the domain. The application of traditional solver packages is narrow and tied to solving handcrafted PDEs. If the problem cannot be cast as the solution of a PDE, these solvers cannot be applied. Thus, these packages may be unsuited for learning solutions from data. Technology described herein can be used to train networks that learn to process the data from examples.

Octnet convolutions: In 3D deep learning, researchers have made use of adaptive data structures such as octrees to improve runtime efficiency. Since octree information is often sparsely distributed, large regions with no information may be collapsed.

Existing octnet convolution solutions may map standard convolutional kernels to octrees. These kernels cannot be trained to capture relations between different resolutions within the same adaptive grid 22. Not being able to learn this relation may lead to incorrect interpretations of the input data.

FIG. 2 shows a conventional set of convolutions 26 for a standard grid 30 and an adaptive grid 32. For a voxel 24, an octnet convolution approach will produce a common result 28 for both the standard grid 30 and an adaptive grid 32. An enhanced set of convolutions 34, however, demonstrates that technology described herein captures resolution differences between cells and will produce a first result 36 for the adaptive grid 32 and a second result 38 for the standard grid 30. The different results 36, 38 represent improved performance due to the ability of the enhanced set of convolutions 34 to learn from the relations between different resolutions within the adaptive grid 22.

Physics Informed Neural Networks (PINNs): Recent work has explored neural networks to implement shape functions used with the Finite Element Method. These techniques may be used for discretizing the adaptive grid 32, but are also rather specialized to use cases in physics such as traditional simulation software packages. PINNs have a focus on solving PDEs efficiently by learning from data. Technology described herein focuses on applying convolutional neural networks (CNNs) to the adaptive grid 32 and is not limited to PDEs. For instance, embodiments might be used to automate semantic segmentation of sparse volumes or point clouds.

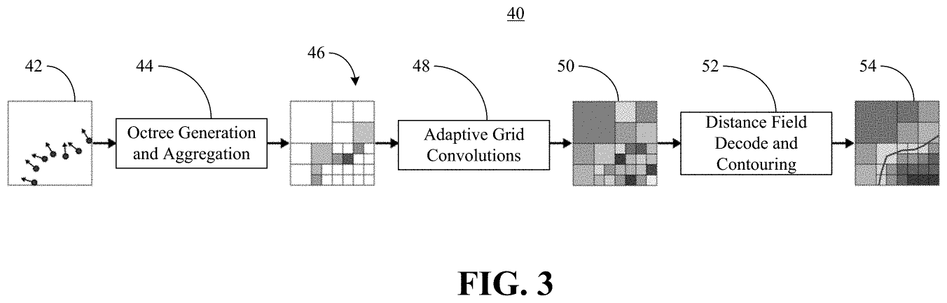

FIG. 3 shows an overview of a pipeline 40 that processes 3D data such as, for example, a point cloud 42 and uses an octree generation and aggregation stage 44 to generate an adaptive grid 46. In one example, the point cloud 42 is obtained from one or multiple scanners (e.g., via a wireless and/or wired network controller). In an embodiment, the pipeline 40 outputs a signed distance field 54 that describes the surface of a scanned object. Embodiments address the processing of the data in the adaptive grid 46 by a convolutions stage 48.

Unlike regular grids, the adaptive grid 46 cannot be processed with standard convolutional neural networks as kernels do not adjust to the grid structure. By contrast, the convolutions stage 48 generates a result 50 that adjusts to the structure of the adaptive grid 46. Accordingly, the signed distance field 54 obtained from a distance field decode and contouring stage 52 is enhanced relative to conventional approaches.

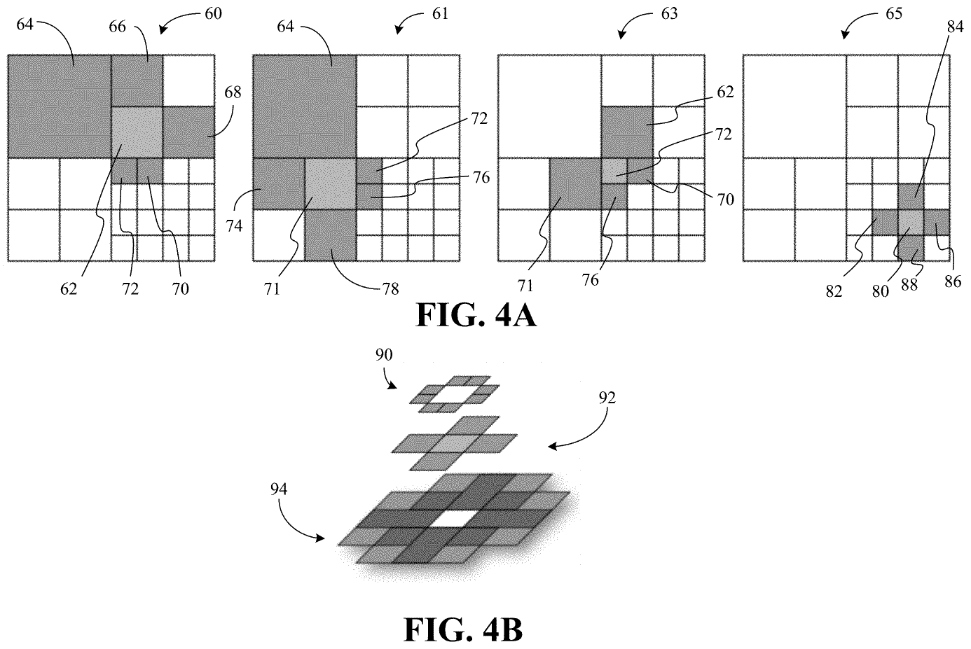

FIGS. 4A and 4B demonstrate that embodiments adapt to the grid structure by using multi-scale kernels for adaptive grids obtained from face-balanced octrees. More particularly, a first instance 60 of an adaptive grid evaluates a convolution at a cell 62 (e.g., center cell) that has cells 64, 66, 68, 70 and 72 as face-adjacent neighbors. A second instance 61 of the adaptive grid evaluates a convolution at a cell 71 (e.g., center cell), which has cells 74, 64, 72, 76, and 78 as face-adjacent neighbors. In another example, a third instance 63 of the adaptive grid evaluates a convolution at the cell 72 (e.g., center cell) that has cells 71, 62, 70 and 76 as face-adjacent neighbors. Similarly, a fourth instance 65 of the adaptive grid evaluates a convolution at a cell 80, which has cells 82, 84, 86, and 88 as face-adjacent neighbors. As best shown in FIG. 4B, a top layer 90 of a multi-scale kernel shows kernel elements for a finer resolution, a middle layer 92 of the multi-scale kernel shows kernel elements for an intermediate resolution, and a bottom layer 94 of the multi-scale kernel shows kernel elements for a coarser resolution. The bottom layer 94 shows a superposition because the elements spatially overlap.

Formally the convolution may be defined as

$$( f * g ) = {\sum }_{i ∈ {𝒩}_{j}} {f}_{i} g ( I ( i , j ) ) \qquad ( 1 )$$

Where f is the function defined by the adaptive grid, g is the multi-scale convolutional kernel, i,j are indices into the grid f, I is a function that computes the index of the kernel element to be used for the two neighboring cells i and j, and Nⱼ is the list of face-adjacent neighbors of cell j.

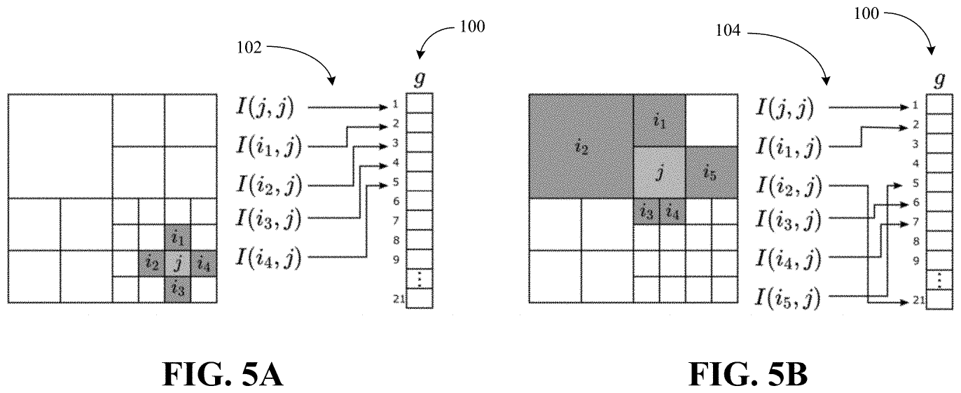

Turning now to FIGS. 5A and 5B, a difference compared to standard convolutions is that the function I computes the index of the element in a multi-scale kernel 100 to be used based on the spatial configuration of the involved cells. I can be efficiently implemented as a hash table (not shown). FIG. 5A shows a first mapping 102 to kernel elements in g for a 2D quadtree configuration having a single resolution (e.g., the relative sizes are equal to one another) and FIG. 5B shows a second mapping 104 to kernel elements in g for a 2D quadtree configuration having multiple resolutions (e.g., two or more of the relative sizes are different from one another).

In both examples, I maps to a subset of the kernel elements and the number of active kernel elements depends on the number of neighbors i. I uses the relative position and size of the cells i and j to map to distinct entries of g. This relative positioning can be observed in the second mapping 104 for the neighbors i₂, i₃, i₄ that are of a different size than j and map to distinct entries.

A condition for computing the mapping I may be the generation of unique keys for each possible spatial configuration. Using the center voxel/cell of the convolution as an origin, the keys can be computed as the relative position of adjacent voxels.

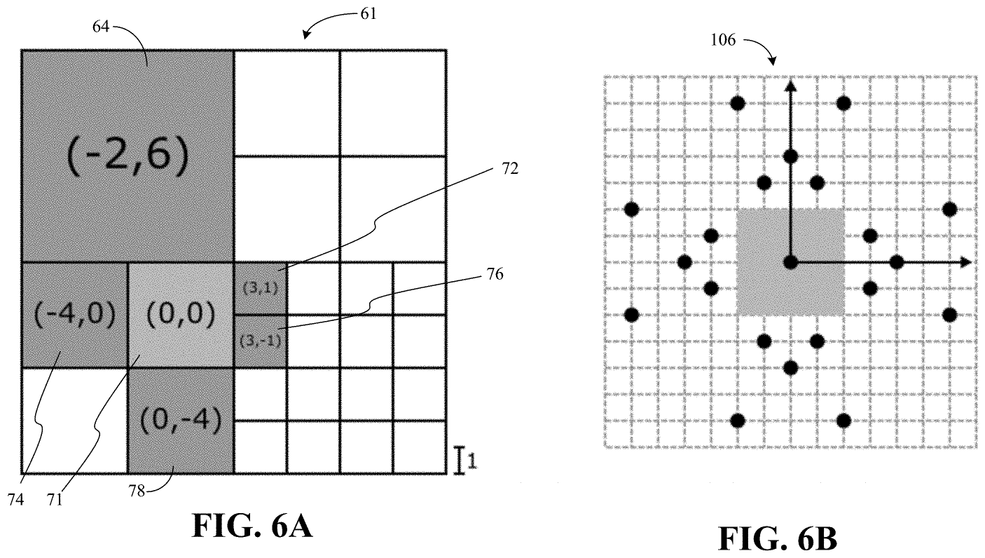

For example, FIGS. 6A and 6B show spatial configuration keys for the second instance 61 of the adaptive grid (see, also, FIG. 4A). As already noted, the spatial configuration keys may be incorporated into a hash table that is used to map the center cell 70 and the face-adjacent neighbor cells 74, 64, 72, 76, and 78 to elements of a multi-scale kernel. FIG. 6B shows the possible relative positions 106 between center cells and face-adjacent neighbor cells. In an embodiment, a fourth of the edge length of the center voxel is used as a unit to keep all coordinates as integers.

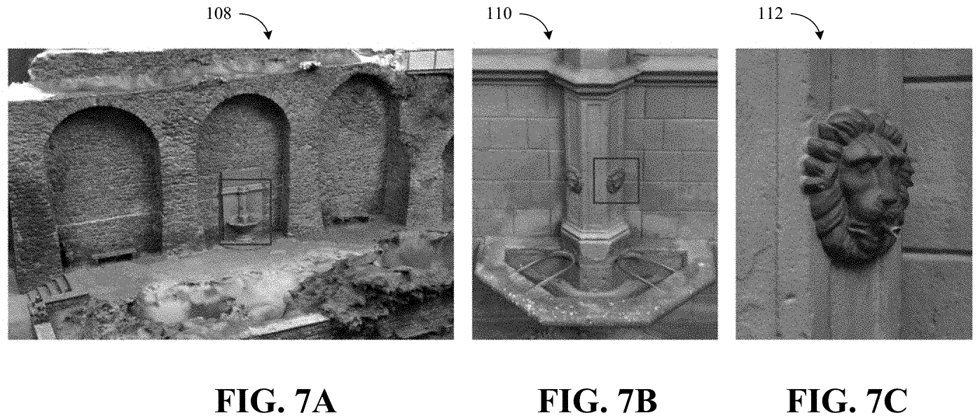

FIGS. 7A-7C show images 108, 110, 112 of a mesh generated from a relatively large number of scans using the convolution technology described herein. Like the adaptive grids, the resolution of the mesh adapts and enables data with points of interest or varying detail to be processed. Conventional solutions do not achieve the same memory and runtime efficiency. Conventional solutions also yield meshes of lower quality within similar compute limits.

In addition to 3D surface reconstruction, embodiments can be useful in other applications where adaptive grids occur. Possible use cases in 2D can be CNNs for post processing images generated with variable rate shading (VRS) or foveated rendering.

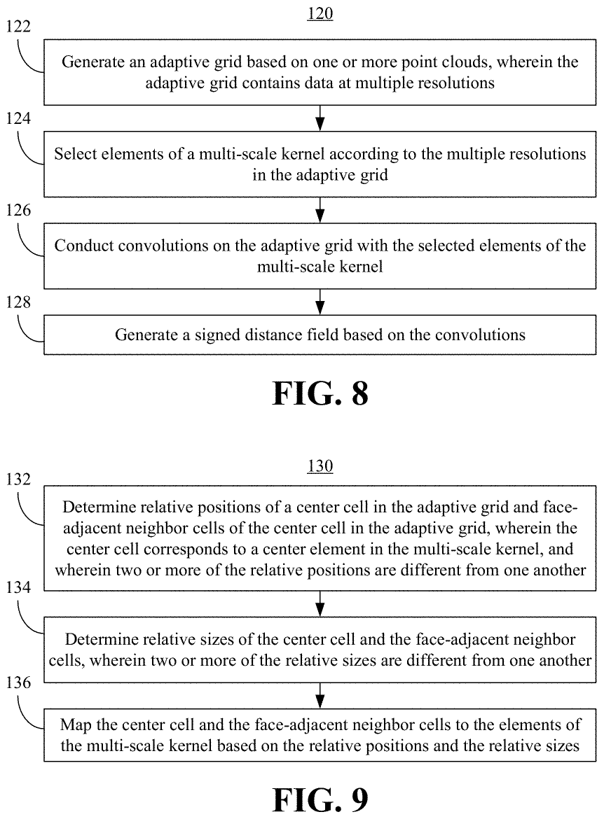

FIG. 8 shows a method 120 of processing point cloud data. The method 120 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable hardware such as, for example, programmable logic arrays (PLAs), field programmable gate arrays (FPGAs), complex programmable logic devices (CPLDs), in fixed-functionality hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 120 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 122 provides for generating an adaptive grid based on one or more point clouds, wherein the adaptive grid contains data at multiple resolutions. Block 124 selects elements of a multi-scale kernel according to the multiple resolutions in the adaptive grid. Additionally, block 126 conducts convolutions on the adaptive grid with the selected elements of the multi-scale kernel. In an embodiment, block 126 includes using Equation (1), already discussed. Illustrated block 128 provides for generating a signed distance field based on the convolutions. In one example, the signed distance field describes a surface of a scanned object. The method 120 therefore enhances performance at least to the extent that selecting elements of a multi-scale kernel according to multiple resolutions in an adaptive grid enables the convolutions to learn from the relative positions and/or relative sizes of voxels/cells in the adaptive grid.

FIG. 9 shows a method 130 of selecting elements of a multi-scale kernel. The method 130 may generally be incorporated into block 124 (FIG. 8), already discussed. More particularly, the method 130 may be implemented as one or more modules in a set of logic instructions stored in a non-transitory machine- or computer-readable storage medium such as RAM, ROM, PROM, firmware, flash memory, etc., in configurable hardware such as, for example, PLAs, FPGAs, CPLDs, in fixed-functionality hardware using circuit technology such as, for example, ASIC, CMOS or TTL technology, or any combination thereof.

Illustrated processing block 132 provides for determining relative positions of a center cell in an adaptive grid and face-adjacent neighbor cells of the center cell in the adaptive grid, wherein the center cell corresponds to a center element (e.g., j in FIGS. 5A and 5B) in a multi-scale kernel. In the illustrated example, two or more of the relative positions are different from one another. Block 134 determines relative sizes of the center cell and the face-adjacent neighbor cells. In the illustrated example, two or more of the relative sizes are different from one another (see, e.g., FIG. 5B). Alternatively, the relative sizes may be equal to one another (see, e.g., FIG. 5A). Block 136 may map the center cell and the face-adjacent neighbor cells to the elements of the multi-scale kernel based on the relative positions and the relative sizes. In an embodiment, block 136 maps the center cell and the face-adjacent neighbor cells to the elements of the multi-scale kernel via a hash table. Additionally, the hash table may include a plurality of spatial configuration keys.

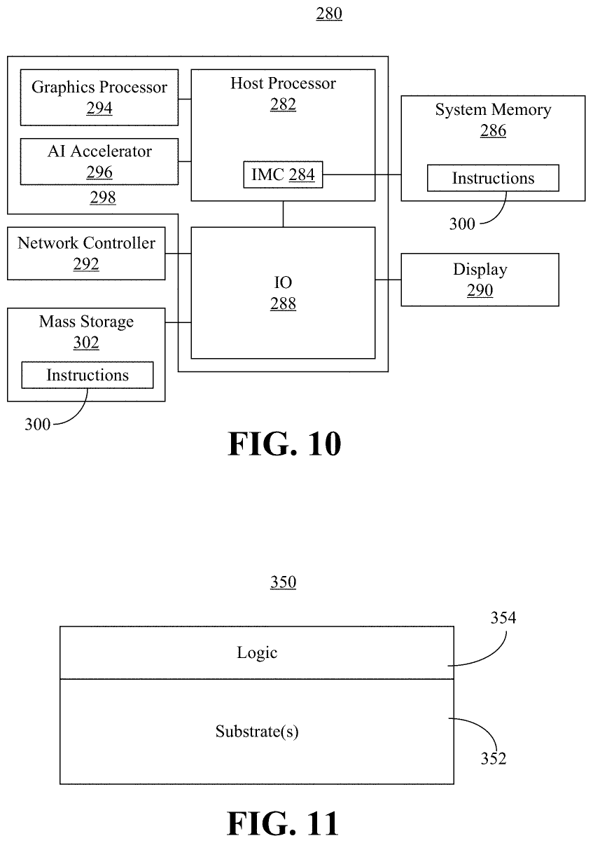

Turning now to FIG. 10, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., CPU) having an integrated memory controller (IMC) 284 that is coupled to a system memory 286 (e.g., dual inline memory module/DIM M). In an embodiment, an IO module 288 is coupled to the host processor 282. The illustrated IO module 288 communicates with, for example, a display 290 (e.g., touch screen, liquid crystal display/LCD, light emitting diode/LED display), and a network controller 292 (e.g., wired and/or wireless). The host processor 282 may be combined with the 10 module 288, a graphics processor 294, and an AI accelerator 296 into a system on chip (SoC) 298.

In an embodiment, the host processor 282 executes a set of program instructions 300 retrieved from mass storage 302 and/or the system memory 286 to perform one or more aspects of the method 120 (FIG. 8) and/or the method 130 (FIG. 9), already discussed. Thus, execution of the illustrated instructions 300 by the host processor 282 causes the host processor 282 to select elements of a multi-scale kernel according to resolutions in an adaptive grid, conduct convolutions on the adaptive grid with the selected elements of the multi-scale kernel, and generate a signed distance field based on the convolutions. The computing system 280 is therefore considered performance-enhanced at least to the extent that selecting the elements of the multi-scale kernel according to multiple resolutions in the adaptive grid enables the convolutions to learn from the relative positions and/or relative sizes of voxels/cells in the adaptive grid.

FIG. 11 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 120 (FIG. 8) and/or the method 130 (FIG. 9), already discussed. The semiconductor apparatus 350 may also be incorporated into the AI accelerator 296 (FIG. 10). The semiconductor apparatus 350 is therefore considered performance-enhanced at least to the extent that selecting the elements of a multi-scale kernel according to multiple resolutions in an adaptive grid enables convolutions to learn from the relative positions and/or relative sizes of voxels/cells in the adaptive grid.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

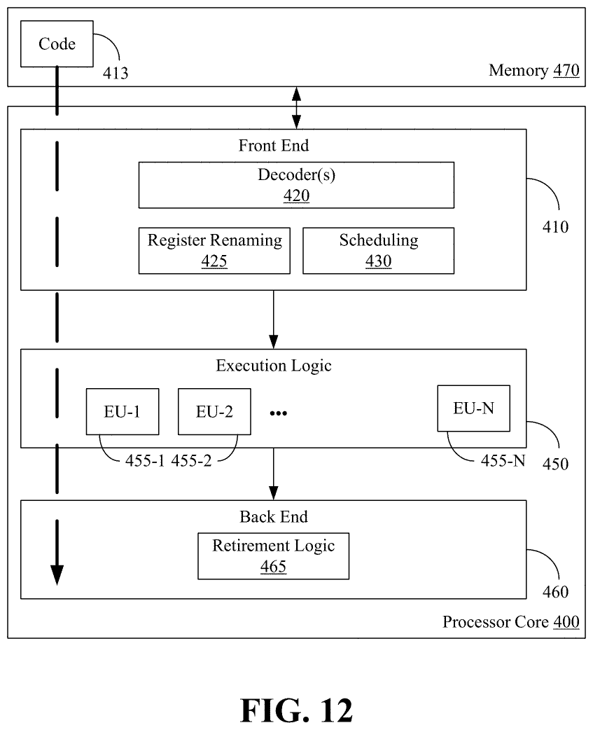

FIG. 12 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 12, a processing element may alternatively include more than one of the processor core 400 illustrated in FIG. 12. The processor core 400 may be a single-threaded core or, for at least one embodiment, the processor core 400 may be multithreaded in that it may include more than one hardware thread context (or “logical processor”) per core.

FIG. 12 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 120 (FIG. 8) and/or the method 130 (FIG. 9), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 12, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

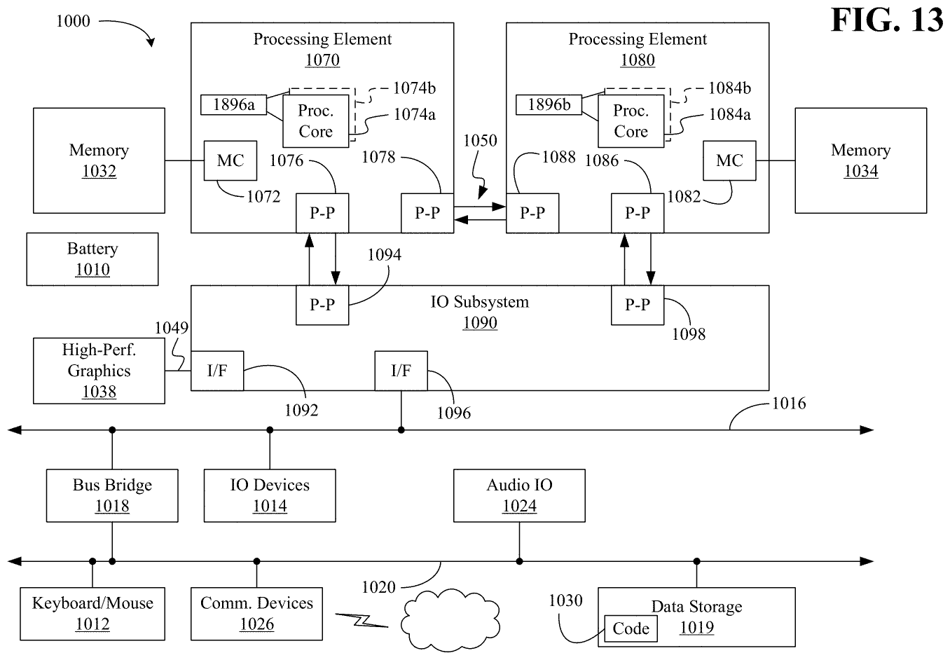

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 120 (FIG. 8) and/or the method 130 (FIG. 9), already discussed. Further, an audio I/O 1024 may be coupled to second bus 1020 and a battery 1010 may supply power to the computing system 1000.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

### ADDITIONAL NOTES AND EXAMPLES

Example 1 includes a performance-enhanced computing system comprising a network controller, a processor coupled to the network controller, and a memory coupled to the processor, the memory including a set of instructions, which when executed by the processor, cause the processor to select elements of a multi-scale kernel according to resolutions in an adaptive grid, conduct convolutions on the adaptive grid with the selected elements of the multi-scale kernel, and generate a signed distance field based on the convolutions.

Example 2 includes the computing system of Example 1, wherein to select the elements of the multi-scale kernel, the instructions, when executed, further cause the processor to determine relative positions of a center cell in the adaptive grid and face-adjacent neighbor cells of the center cell in the adaptive grid, wherein the center cell is to correspond to a center element in the multi-scale kernel, and wherein two or more of the relative positions are to be different from one another, determine relative sizes of the center cell and the face-adjacent neighbor cells, and map the center cell and the face-adjacent neighbor cells to the elements of the multi-scale kernel based on the relative positions and the relative sizes.

Example 3 includes the computing system of Example 2, wherein the center cell and the face-adjacent neighbor cells are mapped to the elements of the multi-scale kernel via a hash table, and wherein the hash table is to include a plurality of spatial configuration keys.

Example 4 includes the computing system of Example 2, wherein two or more of the relative sizes are to be different from one another.

Example 5 includes the computing system of Example 2, wherein the relative sizes are to be equal to one another.

Example 6 includes the computing system of any one of Examples 1 to 5, wherein the instructions, when executed, further cause the computing system to generate the adaptive grid based on one or more point clouds, wherein the adaptive grid is to contain data at multiple resolutions, and wherein the signed distance field is to describe a surface of a scanned object.

Example 7 includes at least one computer readable storage medium comprising a set of instructions, which when executed by a computing system, cause the computing system to select elements of a multi-scale kernel according to resolutions in an adaptive grid, conduct convolutions on the adaptive grid with the selected elements of the multi-scale kernel, and generate a signed distance field based on the convolutions.

Example 8 includes the at least one computer readable storage medium of Example 7, wherein to select the elements of the multi-scale kernel, the instructions, when executed, further cause the computing system to determine relative positions of a center cell in the adaptive grid and face-adjacent neighbor cells of the center cell in the adaptive grid, wherein the center cell is to correspond to a center element in the multi-scale kernel, and wherein two or more of the relative positions are to be different from one another, determine relative sizes of the center cell and the face-adjacent neighbor cells, and map the center cell and the face-adjacent neighbor cells to the elements of the multi-scale kernel based on the relative positions and the relative sizes.

Example 9 includes the at least one computer readable storage medium of Example 8, wherein the center cell and the face-adjacent neighbor cells are mapped to the elements of the multi-scale kernel via a hash table, and wherein the hash table is to include a plurality of spatial configuration keys.

Example 10 includes the at least one computer readable storage medium of Example 8, wherein two or more of the relative sizes are to be different from one another.

Example 11 includes the at least one computer readable storage medium of Example 8, wherein the relative sizes are to be equal to one another.

Example 12 includes the at least one computer readable storage medium of any one of Examples 7 to 11, wherein the instructions, when executed, further cause the computing system to generate the adaptive grid based on one or more point clouds, wherein the adaptive grid is to contain data at multiple resolutions, and wherein the signed distance field is to describe a surface of a scanned object.

Example 13 includes a semiconductor apparatus comprising one or more substrates, and logic coupled to the one or more substrates, wherein the logic is implemented at least partly in one or more of configurable or fixed-functionality hardware, the logic to select elements of a multi-scale kernel according to resolutions in an adaptive grid, conduct convolutions on the adaptive grid with the selected elements of the multi-scale kernel, and generate a signed distance field based on the convolutions.

Example 14 includes the semiconductor apparatus of Example 13, wherein to select the elements of the multi-scale kernel, the logic is to determine relative positions of a center cell in the adaptive grid and face-adjacent neighbor cells of the center cell in the adaptive grid, wherein the center cell is to correspond to a center element in the multi-scale kernel, and wherein two or more of the relative positions are to be different from one another, determine relative sizes of the center cell and the face-adjacent neighbor cells, and map the center cell and the face-adjacent neighbor cells to the elements of the multi-scale kernel based on the relative positions and the relative sizes.

Example 15 includes the semiconductor apparatus of Example 14, wherein the center cell and the face-adjacent neighbor cells are mapped to the elements of the multi-scale kernel via a hash table, and wherein the hash table is to include a plurality of spatial configuration keys.

Example 16 includes the semiconductor apparatus of Example 14, wherein two or more of the relative sizes are to be different from one another.

Example 17 includes the semiconductor apparatus of Example 14, wherein the relative sizes are to be equal to one another.

Example 18 includes the semiconductor apparatus of any one of Examples 13 to 17, wherein the logic is to generate the adaptive grid based on one or more point clouds, wherein the adaptive grid is to contain data at multiple resolutions, and wherein the signed distance field is to describe a surface of a scanned object.

Example 19 includes the semiconductor apparatus of any one of Examples 13 to 18, wherein the logic coupled to the one or more substrates includes transistor channel regions that are positioned within the one or more substrates.

Example 20 includes a method of operating a performance-enhanced computing system, the method comprising selecting elements of a multi-scale kernel according to resolutions in an adaptive grid, conducting convolutions on the adaptive grid with the selected elements of the multi-scale kernel, and generating a signed distance field based on the convolutions.

Example 21 includes the method of Example 20, wherein selecting the elements of the multi-scale kernel includes determining relative positions of a center cell in the adaptive grid and face-adjacent neighbor cells of the center cell in the adaptive grid, wherein the center cell corresponds to a center element in the multi-scale kernel, and wherein two or more of the relative positions are different from one another, determining relative sizes of the center cell and the face-adjacent neighbor cells, and mapping the center cell and the face-adjacent neighbor cells to the elements of the multi-scale kernel based on the relative positions and the relative sizes.

Example 22 includes the method of Example 21, wherein the center cell and the face-adjacent neighbor cells are mapped to the elements of the multi-scale kernel via a hash table, and wherein the hash table includes a plurality of spatial configuration keys.

Example 23 includes the method of Example 21, wherein two or more of the relative sizes are different from one another.

Example 24 includes the method of Example 21, wherein the relative sizes are equal to one another.

Example 25 includes the method of any one of Examples 20 to 24, further including generating the adaptive grid based on one or more point clouds, and wherein the adaptive grid contains data at multiple resolutions, and wherein the signed distance field describes a surface of a scanned object.

Example 26 includes an apparatus comprising means for performing the method of any one of Examples 20 to 25.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of instructions, which when executed by the processor, cause the processor to:
select elements of a multi-scale kernel according to resolutions in an adaptive grid,
conduct convolutions on the adaptive grid with the selected elements of the multi-scale kernel, and
generate a signed distance field based on the convolutions.

2. The computing system of claim 1, wherein to select the elements of the multi-scale kernel, the instructions, when executed, further cause the processor to:
determine relative positions of a center cell in the adaptive grid and face-adjacent neighbor cells of the center cell in the adaptive grid, wherein the center cell is to correspond to a center element in the multi-scale kernel, and wherein two or more of the relative positions are to be different from one another,
determine relative sizes of the center cell and the face-adjacent neighbor cells, and
map the center cell and the face-adjacent neighbor cells to the elements of the multi-scale kernel based on the relative positions and the relative sizes.

3. The computing system of claim 2, wherein the center cell and the face-adjacent neighbor cells are mapped to the elements of the multi-scale kernel via a hash table, and wherein the hash table is to include a plurality of spatial configuration keys.

4. The computing system of claim 2, wherein two or more of the relative sizes are to be different from one another.

5. The computing system of claim 2, wherein the relative sizes are to be equal to one another.

6. The computing system of claim 1, wherein the instructions, when executed, further cause the computing system to generate the adaptive grid based on one or more point clouds, wherein the adaptive grid is to contain data at multiple resolutions, and wherein the signed distance field is to describe a surface of a scanned object.

7. At least one computer readable storage medium comprising a set of instructions, which when executed by a computing system, cause the computing system to:
select elements of a multi-scale kernel according to resolutions in an adaptive grid;
conduct convolutions on the adaptive grid with the selected elements of the multi-scale kernel; and
generate a signed distance field based on the convolutions.

8. The at least one computer readable storage medium of claim 7, wherein to select the elements of the multi-scale kernel, the instructions, when executed, further cause the computing system to:
determine relative positions of a center cell in the adaptive grid and face-adjacent neighbor cells of the center cell in the adaptive grid, wherein the center cell is to correspond to a center element in the multi-scale kernel, and wherein two or more of the relative positions are to be different from one another;
determine relative sizes of the center cell and the face-adjacent neighbor cells; and
map the center cell and the face-adjacent neighbor cells to the elements of the multi-scale kernel based on the relative positions and the relative sizes.

9. The at least one computer readable storage medium of claim 8, wherein the center cell and the face-adjacent neighbor cells are mapped to the elements of the multi-scale kernel via a hash table, and wherein the hash table is to include a plurality of spatial configuration keys.

10. The at least one computer readable storage medium of claim 8, wherein two or more of the relative sizes are to be different from one another.

11. The at least one computer readable storage medium of claim 8, wherein the relative sizes are to be equal to one another.

12. The at least one computer readable storage medium of claim 7, wherein the instructions, when executed, further cause the computing system to generate the adaptive grid based on one or more point clouds, wherein the adaptive grid is to contain data at multiple resolutions, and wherein the signed distance field is to describe a surface of a scanned object.

13. A semiconductor apparatus comprising:
one or more substrates; and
logic coupled to the one or more substrates, wherein the logic is implemented at least partly in one or more of configurable or fixed-functionality hardware, the logic to:
select elements of a multi-scale kernel according to resolutions in an adaptive grid;
conduct convolutions on the adaptive grid with the selected elements of the multi-scale kernel; and
generate a signed distance field based on the convolutions.

14. The semiconductor apparatus of claim 13, wherein to select the elements of the multi-scale kernel, the logic is to:
determine relative positions of a center cell in the adaptive grid and face-adjacent neighbor cells of the center cell in the adaptive grid, wherein the center cell is to correspond to a center element in the multi-scale kernel, and wherein two or more of the relative positions are to be different from one another;
determine relative sizes of the center cell and the face-adjacent neighbor cells; and
map the center cell and the face-adjacent neighbor cells to the elements of the multi-scale kernel based on the relative positions and the relative sizes.

15. The semiconductor apparatus of claim 14, wherein the center cell and the face-adjacent neighbor cells are mapped to the elements of the multi-scale kernel via a hash table, and wherein the hash table is to include a plurality of spatial configuration keys.

16. The semiconductor apparatus of claim 14, wherein two or more of the relative sizes are to be different from one another.

17. The semiconductor apparatus of claim 14, wherein the relative sizes are to be equal to one another.

18. The semiconductor apparatus of claim 13, wherein the logic is to generate the adaptive grid based on one or more point clouds, wherein the adaptive grid is to contain data at multiple resolutions, and wherein the signed distance field is to describe a surface of a scanned object.

19. The semiconductor apparatus of claim 13, wherein the logic coupled to the one or more substrates includes transistor channel regions that are positioned within the one or more substrates.

20. A method comprising:
selecting elements of a multi-scale kernel according to resolutions in an adaptive grid;
conducting convolutions on the adaptive grid with the selected elements of the multi-scale kernel; and
generating a signed distance field based on the convolutions.

21. The method of claim 20, wherein selecting the elements of the multi-scale kernel includes:
determining relative positions of a center cell in the adaptive grid and face-adjacent neighbor cells of the center cell in the adaptive grid, wherein the center cell corresponds to a center element in the multi-scale kernel, and wherein two or more of the relative positions are different from one another;
determining relative sizes of the center cell and the face-adjacent neighbor cells; and
mapping the center cell and the face-adjacent neighbor cells to the elements of the multi-scale kernel based on the relative positions and the relative sizes.

22. The method of claim 21, wherein the center cell and the face-adjacent neighbor cells are mapped to the elements of the multi-scale kernel via a hash table, and wherein the hash table includes a plurality of spatial configuration keys.

23. The method of claim 21, wherein two or more of the relative sizes are different from one another.

24. The method of claim 21, wherein the relative sizes are equal to one another.

25. The method of claim 20, further including generating the adaptive grid based on one or more point clouds, and wherein the adaptive grid contains data at multiple resolutions, and wherein the signed distance field describes a surface of a scanned object.
